(19) United States
(12) Patent Application Publication
(10) Pub. No.: US 2022/0137852 A1
(43) Pub. Date: May 5, 2022

(54) SYSTEM AND METHOD FOR DETECTING EVENT ANOMALIES USING A NORMALIZATION MODEL ON A SET OF STORAGE DEVICES

(71) Applicant: EMC IP Holding Company LLC, Hopkinton, MA (US)

(72) Inventors: Rômulo Teixeira De Abreu Pinho, Niterói (BR); Roberto Nery Stelling Neto, Rio de Janeiro (BR); Rodrigo Rios Almeida De Souza, Rio de Janeiro (BR); Vitor Silva Sousa, Los Angeles, CA (US)

(21) Appl. No.: 17/083,424

(22) Filed: Oct. 29, 2020

(51) Int. Cl. G06F 3/06; G06F 16/28; G06N 20/10; G06N 3/08

(52) U.S. Cl. CPC G06F 3/0653; G06F 16/285; G06F 3/0604; G06F 3/0677; G06N 3/08; G06F 3/0679; G06F 3/0676; G06N 20/10

(57) ABSTRACT

A method for managing storage devices includes obtaining, by a storage device event manager, a set of storage device telemetry snapshots is associated with a set of storage devices, generating a telemetry summary correlation matrix using the set of storage device telemetry snapshots, performing, using the telemetry summary correlation matrix, a classification of each storage device in the set of storage devices to obtain a set of classification tags using a first portion of a set of features, obtaining a set of normality states for the set of storage devices using the set of classification tags and a second portion of the set of features, updating an event anomaly policy based on the set of normality states, and performing a remediation action on a storage device in the set of storage devices based on the event anomaly policy.

### BACKGROUND

Computing devices in a system may include any number of computing resources such as processors, memory, and persistent storage. The computing resources, specifically the persistent storage devices, over time may experience event anomalies. The event anomalies may not be detected until long periods of time have elapsed. The more time elapses after anomalies, the more data that may be lost.

### SUMMARY

In general, in one aspect, the invention relates to a method for managing a plurality of storage devices. The method includes obtaining, by a storage device event manager, a set of storage device telemetry snapshots associated with a set of storage devices, generating a telemetry summary correlation matrix using the set of storage device telemetry snapshots, performing, using the telemetry summary correlation matrix, a classification of each storage device in the set of storage devices to obtain a set of classification tags using a first portion of a set of features, obtaining a set of normality states for the set of storage devices using the set of classification tags and a second portion of the set of features, updating an event anomaly policy based on the set of normality states, and performing a remediation action on a storage device in the set of storage devices based on the event anomaly policy.

In one aspect, the invention relates to a non-transitory computer readable medium that includes computer readable program code, which when executed by a computer processor enables the computer processor to perform a method for managing a plurality of storage devices. The method includes obtaining, by a storage device event manager, a set of storage device telemetry snapshots associated with a set of storage devices, generating a telemetry summary correlation matrix using the set of storage device telemetry snapshots, performing, using the telemetry summary correlation matrix, a classification of each storage device in the set of storage devices to obtain a set of classification tags using a first portion of a set of features, obtaining a set of normality states for the set of storage devices using the set of classification tags and a second portion of the set of features, updating an event anomaly policy based on the set of normality states, and performing a remediation action on a storage device in the set of storage devices based on the event anomaly policy.

In one aspect, the invention relates to a system that includes a processor and memory that includes instructions which, when executed by the processor, perform a method. The method includes obtaining, by a storage device event manager, a set of storage device telemetry snapshots associated with a set of storage devices, generating a telemetry summary correlation matrix using the set of storage device telemetry snapshots, performing, using the telemetry summary correlation matrix, a classification of each storage device in the set of storage devices to obtain a set of classification tags using a first portion of a set of features, obtaining a set of normality states for the set of storage devices using the set of classification tags and a second portion of the set of features, updating an event anomaly policy based on the set of normality states, and performing a remediation action on a storage device in the set of storage devices based on the event anomaly policy.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2A shows a flowchart for generating a normalization model in accordance with one or more embodiments of the invention.

FIG. 2B shows a flowchart for managing event anomaly policies on a set of storage devices in accordance with one or more embodiments of the invention.

FIGS. 3A-3E show an example in accordance with one or more embodiments of the invention.

FIG. 4 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to a method and system for managing storage devices. The storage devices may be monitored to obtain a set of telemetry snapshots that may be used to generate a normality model. The normality model may be a model that specifies normal behavior of storage devices. The normality model may be used to determine whether a storage device behaves normally. Storage devices not behaving normally may be tagged accordingly. Event anomaly policies may be updated based on this determination. The update and implementation of the updated event anomaly policies may result in performing remedial actions for the storage devices determined not to be behaving normally.

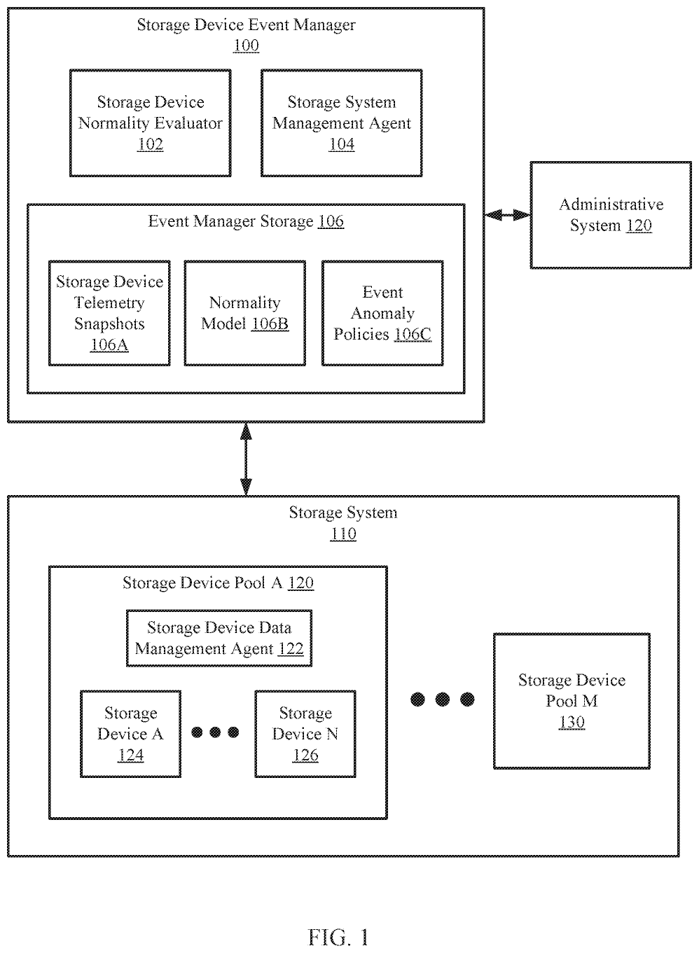

FIG. 1 shows a diagram of a system in accordance with one or more embodiments of the invention. The system may include a storage device event manager (100), a storage system (110), and an administrative system (120). Each component of the system may be operably connected via any combination of wired and/or wireless connections. The system may include additional, fewer, and/or different components without departing from the invention. Each component of the system illustrated in FIG. 1 is discussed below.

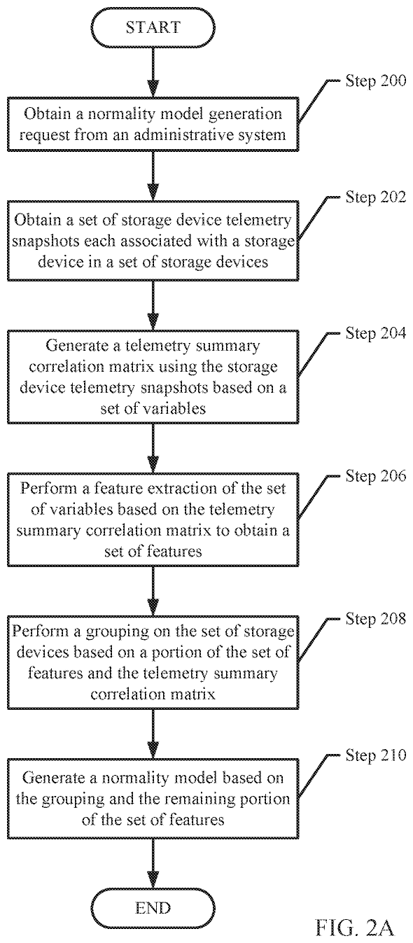

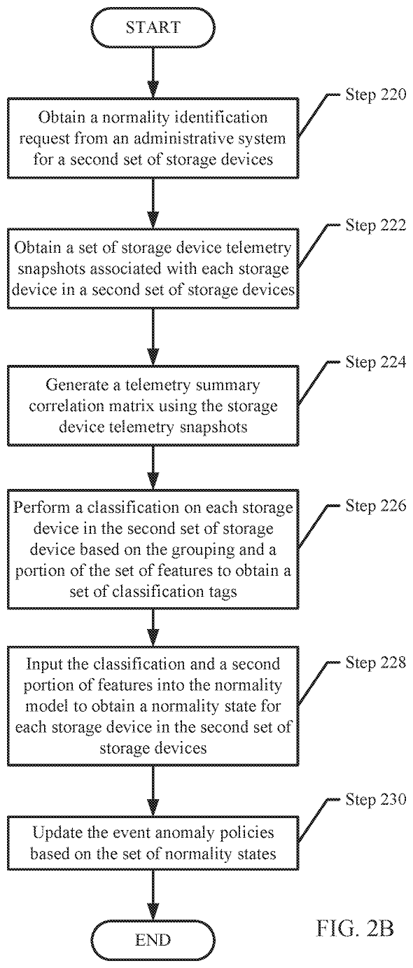

In one or more embodiments of the invention, the storage device event manager (100) manages the storage devices (e.g., 124, 126) in the storage system (110). Specifically, the storage device event manager (100) generates a normality model (106B) based on telemetry obtained from the storage system (110). The normality model (106B) may be generated in accordance with FIG. 2A. The storage device event manager (100) may further include functionality for implementing event anomaly policies (106C) (discussed below). To perform the aforementioned functionality, the storage device event manager (100) includes a storage device normality evaluator (102), a storage system management agent (104), and event manager storage (106). The storage device event manager (100) may include additional, fewer, and/or different components without departing from the invention. Each component of the storage device event manager (100) illustrated in FIG. 1 is discussed below.

In one or more embodiments of the invention, the storage device normality evaluator (102) monitors telemetry (e.g., storage device telemetry snapshots (106A)) obtained from storage device pools (e.g., 120, 130). The telemetry may be used to generate the normality model (106B) in accordance with FIG. 2A. The normality model (106B) may be used to determine whether a storage device has an increased risk of an event anomaly. In one or more embodiments of the invention, an event anomaly is an event that results in data loss, data unavailability, and/or any other event that unexpectedly prevents a user from accessing data in a storage device (e.g., 124, 126). A likelihood of an event anomaly occurring on a storage device may be increased due to factors such as, for example, an overload of processing by a processor utilizing the data, a high usage of storage capacity of the storage device, a high read rate, a high write rate, and/or any combination thereof.

In one or more embodiments of the invention, the storage system management agent (104) implements the event anomaly policies (106C). Specifically, the storage system management agent (104) performs remediation actions (discussed below with the event anomaly policies (104)) to reduce the likelihood of event anomalies in the storage devices in the storage system (110). The remediation actions may include, for example: (i) transferring data from a storage device predicted to have high likelihood of an event anomaly to a second storage device not predicted to have a high likelihood of an event anomaly, reducing the read rate of data in a storage device, (ii) reducing the write rate to the data in the storage device, and (iii) replacing the storage device with a newer storage device. Other remediation actions may be performed without departing from the invention.

In one or more embodiments of the invention, the storage device telemetry snapshots (106A) are data structures that specify telemetry associated with the storage devices (e.g., 124, 126) as provided by the storage device pools (120, 130) associated with the corresponding storage devices. The storage device telemetry snapshots (106A) may be organized as time series (e.g., data sets that each specify a variable of a set of variables as functions over time). Examples of variables include, but are not limited to: a read byte rate, a size of data in a file system stored by the storage device, a maximum number of users accessing the storage devices, an amount of data accessed in the storage device, a number of error messages, a total storage capacity usage of the storage device, and a write rate of data to the storage device.

In one or more embodiments of the invention, the normality model (106B) is a model that relates classifications of storage devices to a normality state. In one or more embodiments of the invention, a normality state is an assignment on a storage device that specifies whether the storage device is at a high risk of an event anomaly. As discussed above, the normality model (106B) may be generated in accordance with FIG. 2A.

In one or more embodiments of the invention, the event anomaly policies (106C) are data structures that specify policies to be implemented on the storage system (110) based on normality states of the storage devices in the storage system (110). The event anomaly policies (106C) may specify, for example, which storage devices are tagged (or otherwise assigned) an abnormal normality state, and which remediation actions to perform on such storage devices. The event anomaly policies (106C) may be implemented by the storage system management agent (104).

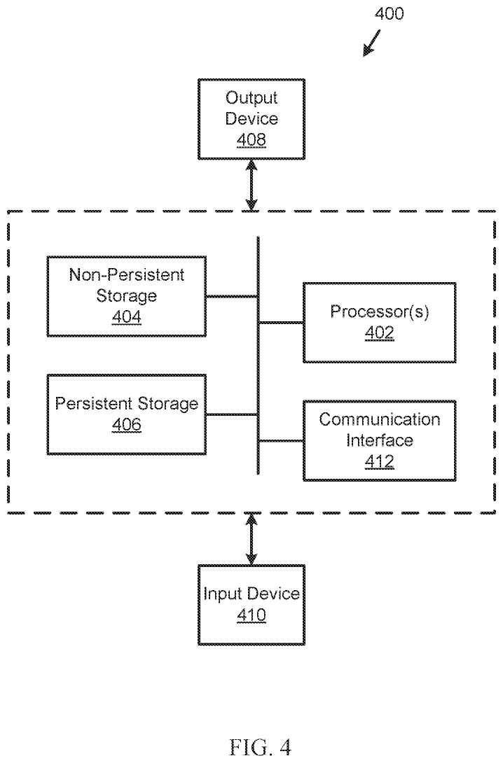

In one or more embodiments of the invention, the storage device event manager (100) is implemented as a computing device (see, e.g., FIG. 4). The computing device may be, for example, a mobile phone, tablet computer, laptop computer, desktop computer, server, or cloud resource. The computing device may include one or more processors, memory (e.g., random access memory), and persistent storage (e.g., disk drives, solid-state drives, etc.). The persistent storage may store computer instructions, e.g., computer code, that when executed by the processor(s) of the computing device cause the computing device to perform the functions of the storage device event manager (100) described in this application.

The storage device event manager (100) may be implemented as a logical device without departing from the invention. The logical device utilizes computing resources of any number of physical computing devices to provide the functionality of the storage device event manager (100) described throughout this application and/or all, or portion, of the method illustrated in FIGS. 2A-2B. For additional details regarding the storage device event manager, see, e.g., FIG. 1B.

In one or more embodiments of the invention, the storage system (110) is a system of storage devices organized in storage device pools (120, 130). Each storage device pool (120, 130) may include a storage device data management agent (e.g., 122) that provides telemetry to the storage device event manager (100) and one or more storage devices (e.g., 124, 126) that store data. Each storage device (124, 126) may be persistent storage (e.g., disk drives, solid state drives, etc.). Each storage device pool (120, 130) may include additional, fewer, and or different components.

In one or more embodiments of the invention, each storage device pool (120, 130) is implemented as a computing device (see, e.g., FIG. 4). A computing device may be, for example, a mobile phone, tablet computer, laptop computer, desktop computer, server, or cloud resource. The computing device may include one or more processors, memory (e.g., random access memory), and persistent storage (e.g., 124, 126). The persistent storage may store computer instructions, e.g., computer code, that when executed by the processor(s) of the computing device cause the computing device to perform the functions of the storage device pool (120, 130) described throughout this application.

A storage device pool (120, 130) may be implemented as a logical device without departing from the invention. The logical device utilizes computing resources of any number of physical computing devices to provide the functionality of the storage device pool (120, 130) described throughout this application.

In one or more embodiments of the invention, the administrative system (120) may coordinate with the storage device event manager (100) before, during, and/or after a cleaning process. The administrative system (120) may communicate with the storage device event manager (100) to select configuration options for configuring the normality model (106B) generation and/or the event anomaly policies (106C) implementations.

In one or more embodiments of the invention, the administrative system (120) is implemented as a computing device (see, e.g., FIG. 4). A computing device may be, for example, a mobile phone, tablet computer, laptop computer, desktop computer, server, or cloud resource. The computing device may include one or more processors, memory (e.g., random access memory), and persistent storage (e.g., disk drives, solid-state drives, etc.). The persistent storage may store computer instructions, e.g., computer code, that when executed by the processor(s) of the computing device cause the computing device to perform the functions of the administrative system (120) described throughout this application.

The administrative system (120) may be implemented as a logical device without departing from the invention. The logical device utilizes computing resources of any number of physical computing devices to provide the functionality of the administrative system (120) described throughout this application.

FIG. 2A-2B show flowcharts in accordance with one or more embodiments of the invention. While the various steps in the flowcharts are presented and described sequentially, one of ordinary skill in the relevant art will appreciate that some or all of the steps may be executed in different orders, may be combined or omitted, and some or all steps may be executed in parallel. In one embodiment of the invention, the steps shown in FIG. 2A-2B may be performed in parallel with any other steps shown in FIG. 2A-2B without departing from the scope of the invention.

FIG. 2A shows a flowchart for a method for managing a set of storage devices in accordance with one or more embodiments of the invention. The method shown in FIGS. 2A-2B may be performed by, for example, a storage device event manager (110, FIG. 1A). Other components of the system illustrated in FIG. 1A may perform the method of FIG. 2A without departing from the invention.

Turning to FIG. 2A, in step 200, a normality model generation request is obtained from an administrative system. The normality model generation request may specify generating a normality model to be applied to storage devices in a storage system using telemetry obtained from the storage devices.

In step 202, a set of storage device telemetry snapshots each associated with a storage device in a set of storage devices is obtained. In one or more embodiments of the invention, the set of storage device telemetry snapshots are obtained from storage device data management agents (e.g., 122) that monitor the behavior of the storage devices in their respective storage device pool.

In step 204, a telemetry summary correlation matrix is generated using the set of storage device telemetry snapshots based on a set of variables. In one or more embodiments of the invention, the telemetry summary correlation matrix is a data structure that reorganizes the obtained telemetry to relate the storage devices to each other based on a set of variables. For example, a first iteration of the storage telemetry correlation matrix may be a matrix where each column is a variable in the set of variable, and each column is a storage device. The values in the data items may correspond to statistics associated with the corresponding storage devices for a given variable. The statistics may be, for example, an average or a median value of the given variable over the period of time specified in the storage device telemetry snapshot.

In one or more embodiments of the invention, a second iteration of the telemetry correlation matrix is a set of pairwise correlations between each variable based on the values of the statistics in the first iteration. Specifically, the second iteration of the telemetry correlation matrix may include rows and columns each associated with a variable, and the values in each entry corresponding to a strength of relationship between the two variables. For example, if one variable tends to be of a high value for a large number of storage devices that also have a high value of a second variable, the two storage devices may be considered highly correlated due to the similar nature in which the storage devices behave for both variables. As a second example, if a third variable tends to be of a high value for a large number of storage devices, and these storage devices do not have consistent values for a fourth variable, the third and fourth variable may be associated with a low strength of correlation.

In step 206, a feature extraction of the set of variables is performed based on the telemetry summary correlation matrix to obtain a set of features. In one or more embodiments of the invention, the feature extraction includes identifying pairs of variables with high strength of correlation, and removing one of the two variables in each of such pairs from the set of variables. The remaining variables are categorized into features. In one or more embodiments of the invention, a feature is a category of variables that may be categorized based on a type of variable. Examples of features may include, for example, configuration variables, workload variables, and performance variables. Each remaining variable of the set of variables is used to generate distribution models based on the statistics in the telemetry summary correlation matrix. The distribution model may be a relationship between a value in the corresponding variable and a number of storage devices that are associated with that value. Each distribution model may be further tagged with the corresponding feature.

In step 208, a grouping is performed on the set of storage devices based on the telemetry summary correlation matrix and a portion of the set of features. In one or more embodiments of the invention, the grouping is performed by implementing a classification algorithm on the storage devices based on the distribution models associated with a first portion of the features. The first portion of the features may be determined based on the type of variables. In one or more embodiments of the invention, features associated with how the storage devices are applied are considered part of the first portion of the set of features. For example, the first portion of the set of features may include the configuration features and workload features, for the configuration features and the workload features specify variables applied to the storage devices. In contrast, performance features may be associated with the second portion of features (i.e., the features not used in the grouping) because performance features measure the output of the storage devices (e.g., latency, bit error rate, etc.).

In one or more embodiments of the invention, the classification algorithm is a machine learning algorithm that may include inputting the distribution models of the first portion of the set of features and output a set of groups of the storage devices. Each storage device in a group may be considered to have similar values of the first portion of the set of features. Examples of classification algorithms include, but are not limited to, k-nearest neighbor (kNN), support vector machines (SVM), least squares (SVM), and neural networks.

In step 210, a normality model is generated based on the grouping and the remaining portion of the set of features. In one or more embodiments of the invention, the normality model is generated by implementing a second machine learning algorithm that relates the second portion of the set of features between storage devices in the same groups. The second machine learning algorithm may relate the behavior of the storage devices within a group using the second portion of the set of features to determine how most storage devices in the group behave. The second machine learning algorithm may be, for example, a multi-linear regression that produces in a normalization model that inputs a classification of a storage device and the distribution models of the second portion of the set of features and outputs a normality state. In this manner, using the normalization model, a storage device may be determined to be in a normal state if the behavior of the storage device as described by each of the second set of features is within a normal range of the corresponding group.

FIG. 2B shows a flowchart for a method for managing event anomaly policies on a set of storage devices in accordance with one or more embodiments of the invention. The method shown in FIG. 2B may be performed by, for example, a storage device event manager (110, FIG. 1A). Other components of the system illustrated in FIG. 1A may perform the method of FIG. 2B without departing from the invention.

In step 220, a normality identification request is obtained from the administrative system. The normality identification request may specify making a determination about a second set of storage devices using the normalization model and updating the event anomaly policies to remediate any storage devices predicted to be at high risk of going through event anomalies.

In step 222, a set of storage device telemetry snapshots associated with each storage device in the second set of storage devices is set. In one or more embodiments of the invention, similar to FIG. 2A, the set of storage device telemetry snapshots are obtained from storage device data management agents (e.g., 122) that monitor the behavior of the storage devices in their respective storage device pool.

In step 224, a telemetry summary correlation matrix is generated using the storage device telemetry snapshots. In one or more embodiments of the invention, the telemetry summary correlation matrix is generated similar to the telemetry summary correlation matrix of step 204.

In step 226, a classification is performed on each storage device in the second set of storage devices based on the grouping and the portion of the set of features to obtain a set of classification tags. In one or more embodiments of the invention, the classification includes analyzing the telemetry summary correlation matrix to determine a group (generated in step 208 of FIG. 2A) to assign each storage device based on the first portion of the features as determined in FIG. 2A. Each group may be associated with a classification tag. The storage devices may be assigned a classification tag corresponding to the determined group.

In step 228, the classification and the second portion of features is input into the normality model to obtain a normality state for each storage device in the second set of storage device. In one or more embodiments of the invention, the normality model obtains as an input the classification tag of the storage device and the values of the second portion of features corresponding to the storage device, and the normality model outputs a normality state based on an analysis of the values and whether the values are within the normal ranges.

Based on how the values compare to the normal ranges determined in the normalization model, a normalization state is assigned to each storage device in the second set of storage devices. Storage devices may be assigned a “normal” normalization state if most values of the second portion of the set of features are within the normal ranges. In contrast, storage devices may be assigned an “abnormal” normalization state if there is significant deviance in the values from the normal ranges. Whether the deviance of the values is significant may be determined using the normalization model.

In step 230, the event anomaly policies are updated based on the set of normality states. In one or more embodiments of the invention, the anomaly policies are updated to specify any storage devices in the second set of storage devices that are assigned an abnormal normalization state and to specify which remediation actions to perform on the specified storage devices.

In one or more embodiments of the invention, after the event anomaly policies are updated, the event anomaly policies may be implemented by a storage system management agent. The implementation of the event anomaly policies may include remediation actions performed on the specified storage devices. As discussed above, remediation actions may include, for example: (i) transferring data from a storage device predicted to have high likelihood of an event anomaly to a second storage device not predicted to have a high likelihood of an event anomaly, reducing the read rate of data in a storage device, (ii) reducing the write rate to the data in the storage device, and (iii) replacing the storage device with a newer storage device. Other remediation actions may be performed without departing from the invention.

### Example

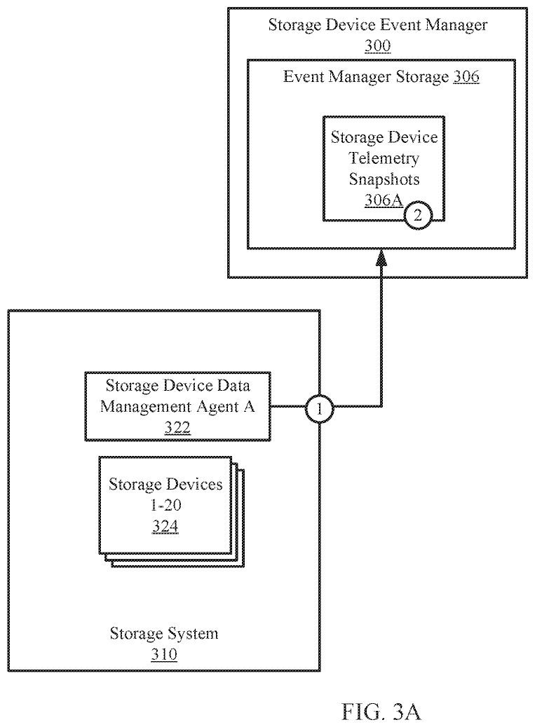

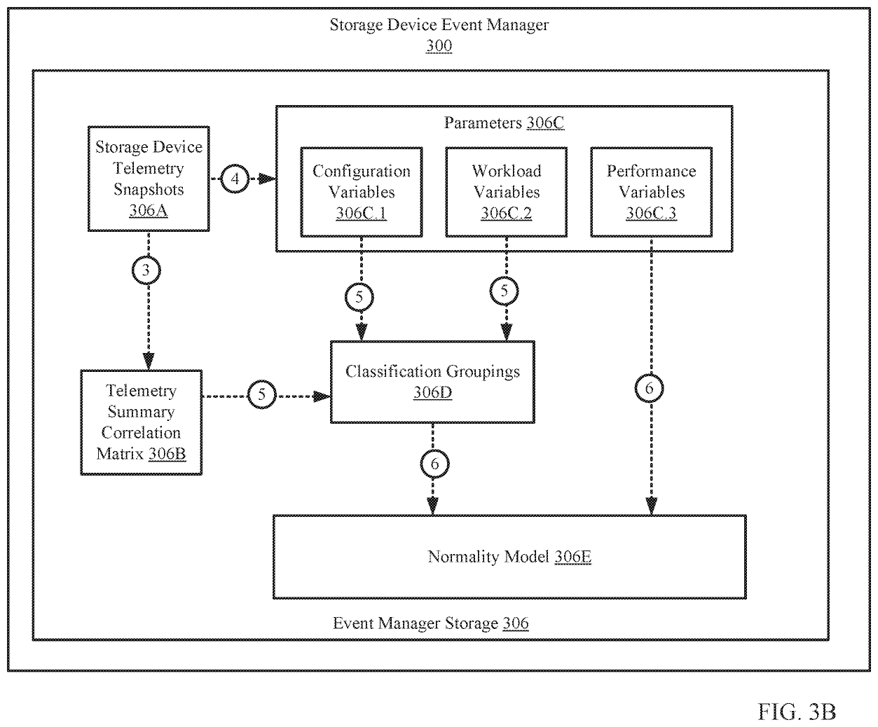

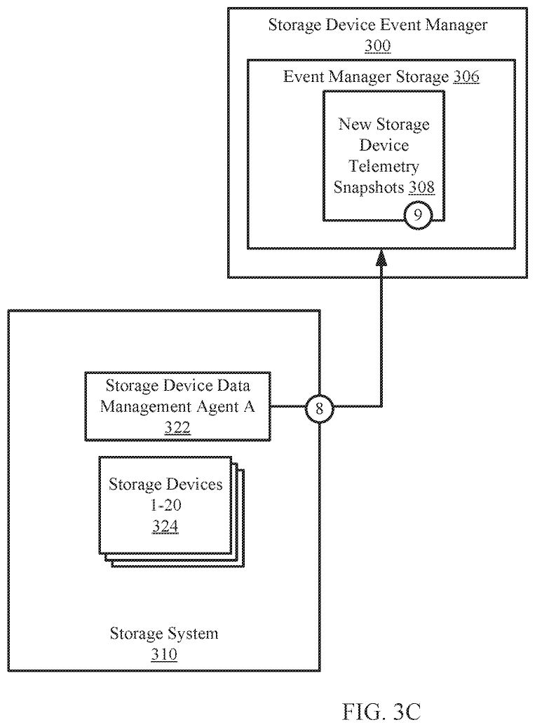

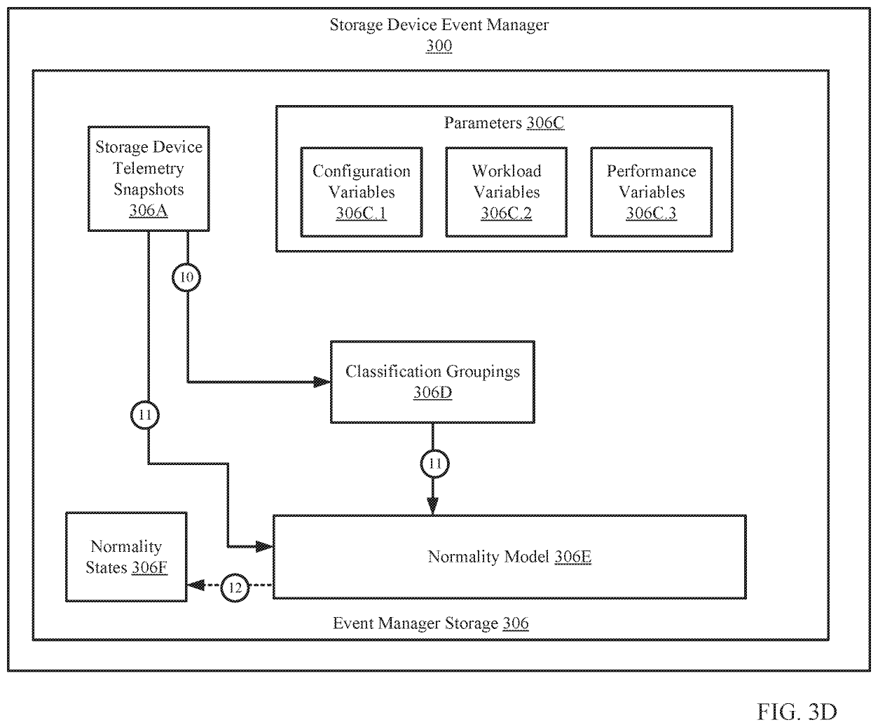

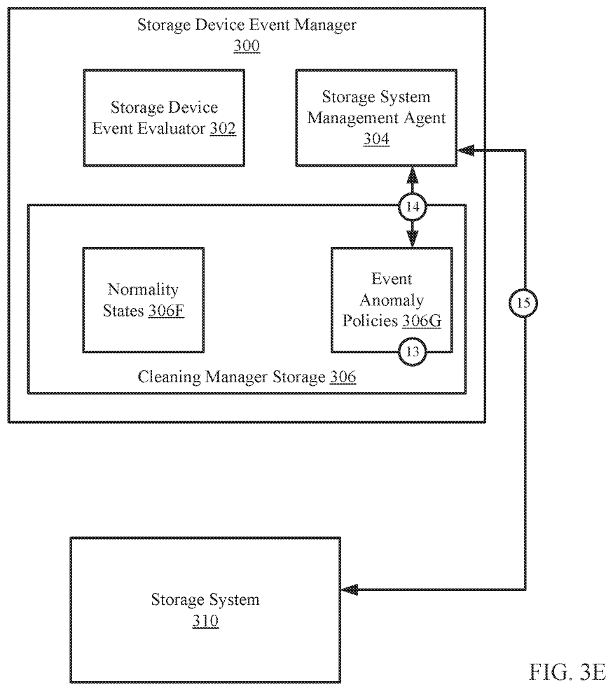

The following section describes an example. The example, illustrated in FIGS. 3A-3E, is not intended to limit the invention. Turning to the example, consider a scenario in which a storage device event manager manages a storage system that includes a set of three storage device pools.

FIG. 3A shows a diagram of an example system. The example system includes a storage device event manager (300) and a storage system (310). For the sake of brevity, not all components of the example system are illustrated in FIG. 3A. Turning to FIG. 3A, the storage system (310) includes a storing device monitoring agent (322) and a set of 20 storage devices (324).

Over a period of six months, the storage device data management agent (322) monitors the behavior of the storage devices (324) and provides a set of storage device telemetry snapshots (306A) to the storage device event manager (300) [1]. Each storage device telemetry snapshot of the set of storage device telemetry snapshot is a time series of a variable of a storage device over any or all of the six-month period. The variable measured in a storage device telemetry snapshot may be: a read rate of data in a storage device, a write rate of the data in a storage device, a number of processors configured to a storage device, a storage device storage capacity usage, a processor usage, and a processor bit error rate. Collectively, the set of storage device telemetry snapshots (306A) includes measurements of all of the aforementioned variables over the six-month period. The set of storage device telemetry snapshots are stored in an event manager storage (306) of the storage device event manager (300) [2].

FIG. 3B shows a second diagram of the example system. For the sake of brevity, not all components of the example system are illustrated in FIG. 3B. At a point in time after the storage device telemetry snapshots (306A) are stored in the event manager storage (306), a telemetry summary correlation matrix (306B) is generated using the storage device telemetry snapshots (306A) in accordance with FIG. 2A [3]. Further, a feature extraction is performed using the telemetry summary correlation matrix to generate a set of features (306C) of independently behaving variables [4]. The features (306C) include configuration variables (306C.1) (in this example, the number of processors configured to each storage device), workload variables (306C.2) (in this example, the average read rates and write rates of each storage device and the average storage capacity usage of each storage device), and performance variables (306C.3) (in this example, the processor bit error rate). The configuration variables (306C.1) and the workload variables (306C.2) are associated with a first portion of the features (306C), and the performance variables (306C.3) are associated with a second portion of the features (306C).

The telemetry summary correlation matrix (306B), the configuration variables (306C.1), and the workload variables (306C.2) are used to generated classification groupings (306D) in accordance with FIG. 2A [5]. The classification groupings (306D) are groupings of the storage devices (not shown in FIG. 3B) that are based on the configuration and workload variables (306C.1, 306C.2). The classification groupings (306D) and the performance variables (306C.3) are used to generate the normality model (306E) in accordance with FIG. 2A.

FIG. 3C shows a third diagram of the example system. For the sake of brevity, not all components of the example system are illustrated in FIG. 3C. At a later point in time, the storage device data management agent (322) provides new storage device telemetry snapshots (308) for each respective storage device in the storage system (310) [8]. The new storage device telemetry snapshots (308) are stored in the event manager storage (306) [9].

FIG. 3D shows a fourth diagram of the example system. For the sake of brevity, not all components of the example system are illustrated in FIG. 3D. After storage of the storage device telemetry snapshots (306A), the method of FIG. 2B is performed. Specifically, the storage device telemetry snapshots (306A) are used to assign classification tags to each storage device. Further, the classification tags of each storage device and the storage device telemetry snapshots associated with the performance variables are input into the previously-generated normality model (306E) [11]. The result of the normality model is generation of normality states (306F) assigned to each storage device. The normality states (306F) may specify that storage devices 2, 7, and 10 are in abnormal states, and that the event anomaly policies need to be updated to perform remediation actions on storage devices 2, 7, and 10.

FIG. 3E shows a fourth diagram of the example system. For the sake of brevity, not all components of the example system are illustrated in FIG. 3E. At a later point in time, the event anomaly policies (306G) are updated in accordance with the normality states (306F) [13]. Further, the storage system management agent (304) implements the event anomaly policies (306G) [14]. Specifically, the storage system management agent (304) identifies, using the event anomaly policies (306G), that storage devices 2, 7, and 10 must be replaced, and initiates transfer of data from the identified storage devices to available storage devices in the storage system (310) [15]. In this manner, a risk of event anomalies in the storage system (310) is proactively minimized.

### End of Example

As discussed above, embodiments of the invention may be implemented using computing devices. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

Embodiments of the invention may improve the efficiency of managing storage devices. Embodiments of the invention may enable a storage device event manager to improve the method for determining whether a storage device in a storage system, which may include a large number of storage devices, is likely to go through an event anomaly. An early detection of such storage devices may reduce data loss and limit the interruption of the operation of data storage in the storage system.

Thus, embodiments of the invention may address the problem of inefficient use of computing resources. This problem arises due to the technological nature of the environment in which storage systems are utilized.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A method for managing a plurality of storage devices, the method comprising:
obtaining, by a storage device event manager, a set of storage device telemetry snapshots associated with a set of storage devices;
generating a telemetry summary correlation matrix using the set of storage device telemetry snapshots;
performing, using the telemetry summary correlation matrix, a classification of each storage device in the set of storage devices to obtain a set of classification tags using a first portion of a set of features;
obtaining a set of normality states for the set of storage devices using the set of classification tags and a second portion of the set of features;
updating an event anomaly policy based on the set of normality states; and
performing a remediation action on a storage device in the set of storage devices based on the event anomaly policy.

2. The method of claim 1, wherein the set of normality states is further obtained using a normality model.

3. The method of claim 2, the method further comprising:
obtaining a second set of storage device telemetry snapshots, wherein the second set of storage device telemetry snapshots is associated with a second set of storage devices;
generating a second telemetry summary correlation matrix using the second set of storage device telemetry snapshots and using a set of variables;
performing a feature extraction on the set of variables to obtain the set of features;
performing a grouping on the second set of storage devices based on the first portion of the set of features and the second telemetry summary correlation matrix; and
generating the normality model based on the grouping and the second portion of the set of features.

4. The method of claim 3, wherein a storage device telemetry snapshot in the second set of storage devices comprises a variable in the set of variables as a function of time.

5. The method of claim 1, wherein the set of storage devices is grouped into storage device pools.

6. The method of claim 1, wherein the remediation action comprises at least one of: transferring data from the storage device to a second storage device, reducing a write rate of the storage device, and replacing the storage device.

7. The method of claim 1,
wherein the first portion of the set of features comprises configuration variables and workload variables, and
wherein the second portion of the set of features comprises performance variables.

8. A non-transitory computer readable medium comprising computer readable program code, which when executed by a computer processor enables the computer processor to perform a method for managing a plurality of storage devices, the method comprising:
obtaining, by a storage device event manager, a set of storage device telemetry snapshots associated with a set of storage devices;
generating a telemetry summary correlation matrix using the set of storage device telemetry snapshots;
performing, using the telemetry summary correlation matrix, a classification of each storage device in the set of storage devices to obtain a set of classification tags using a first portion of a set of features;
obtaining a set of normality states for the set of storage devices using the set of classification tags and a second portion of the set of features;
updating an event anomaly policy based on the set of normality states; and
performing a remediation action on a storage device in the set of storage devices based on the event anomaly policy.

9. The non-transitory computer readable medium of claim 8, wherein the set of normality states is further obtained using a normality model.

10. The non-transitory computer readable medium of claim 9, the method further comprising:
obtaining a second set of storage device telemetry snapshots, wherein the second set of storage device telemetry snapshots is associated with a second set of storage devices;
generating a second telemetry summary correlation matrix using the second set of storage device telemetry snapshots and using a set of variables;
performing a feature extraction on the set of variables to obtain the set of features;
performing a grouping on the second set of storage devices based on the first portion of the set of features and the second telemetry summary correlation matrix; and
generating the normality model based on the grouping and the second portion of the set of features.

11. The non-transitory computer readable medium of claim 10, wherein a storage device telemetry snapshot in the second set of storage devices comprises a variable in the set of variables as a function of time.

12. The non-transitory computer readable medium of claim 8, wherein the set of storage devices is grouped into storage device pools.

13. The non-transitory computer readable medium of claim 8, wherein the remediation action comprises at least one of: transferring data from the storage device to a second storage device, reducing a write rate of the storage device, and replacing the storage device.

14. The non-transitory computer readable medium of claim 8,
wherein the first portion of the set of features comprises configuration variables and workload variables, and
wherein the second portion of the set of features comprises performance variables.

15. A system, comprising:
a processor; and
memory comprising instructions which, when executed by the processor, perform a method, the method comprising:
obtaining, by a storage device event manager, a set of storage device telemetry snapshots associated with a set of storage devices;
generating a telemetry summary correlation matrix using the set of storage device telemetry snapshots;
performing, using the telemetry summary correlation matrix, a classification of each storage device in the set of storage devices to obtain a set of classification tags using a first portion of a set of features;
obtaining a set of normality states for the set of storage devices using the set of classification tags and a second portion of the set of features;
updating an event anomaly policy based on the set of normality states; and
performing a remediation action on a storage device in the set of storage devices based on the event anomaly policy.

16. The system of claim 15, wherein the set of normality states is further obtained using a normality model.

17. The system of claim 16, the method further comprising:
obtaining a second set of storage device telemetry snapshots, wherein the second set of storage device telemetry snapshots is associated with a second set of storage devices;
generating a second telemetry summary correlation matrix using the second set of storage device telemetry snapshots and using a set of variables;
performing a feature extraction on the set of variables to obtain the set of features;
performing a grouping on the second set of storage devices based on the first portion of the set of features and the second telemetry summary correlation matrix; and
generating the normality model based on the grouping and the second portion of the set of features.

18. The system of claim 17, wherein a storage device telemetry snapshot in the second set of storage devices comprises a variable in the set of variables as a function of time.

19. The system of claim 15, wherein the remediation action comprises at least one of: transferring data from the storage device to a second storage device, reducing a write rate of the storage device, and replacing the storage device.

20. The system of claim 15,
wherein the first portion of the set of features comprises configuration variables and workload variables, and
wherein the second portion of the set of features comprises performance variables.
